(19) United States
(12) Patent Application Publication
(10) Pub. No.: US 2012/0048712 A1
(43) Pub. Date: Mar. 1, 2012

(54) SYSTEM FOR PURIFYING LIQUIDS

(75) Inventors: Mazen A. Ba-abbad, Riyadh (SA); Hany Abdulrahman Al-Ansary, Riyadh (SA)

(73) Assignee: King Abdul Aziz City for Science and Technology, Riyadh (SA)

(21) Appl. No.: 12/871,823

(22) Filed: Aug. 30, 2010

(51) Int. Cl. B01D 3/06

(52) U.S. Cl. 202/176

(57) ABSTRACT

A system for purifying a liquid mixture including a liquid and one or more anti-scalants is disclosed. The system includes a heat exchanger chamber and a conduit at least partly housed within the heat exchanger chamber for receiving one or more hot industrial exhaust gases. The conduit is configured with one or more pipes capable of receiving and heating the liquid mixture using at least a part of heat energy obtained from the one or more hot industrial exhaust gases present within the conduit. The system also includes a condensation unit configured within the heat exchanger chamber to receive and condense vapors generated by heating the liquid mixture to obtain a purified liquid.

### FIELD OF THE INVENTION

The invention generally relates to purification of liquids. More specifically, the invention relates to a system for purifying liquids using anti-scalants and hot industrial exhaust gases.

### BACKGROUND OF THE INVENTION

Shortage of fresh water supplies for human consumption, industrial use and agricultural use is one of the major problems in the world. Since, natural sources of fresh water are limited or even scarce in few geographical areas, efforts have been continuously made to explore newer alternatives. For example, efforts have been made to obtain fresh water from unconventional processes, such as, desalination of sea water and purification of sewage water or industrial processing of water. However, high volume purification of contaminated water still remains a major technical and economical challenge.

Several conventional systems for purifying the contaminated water include, for example, mechanical purification systems and thermal purification systems. The mechanical purification systems, such as, those based on reverse osmosis, require the use of costly membranes or filters to separate foreign objects from the contaminated water. These foreign objects are concentrated in a drain liquid that needs to be further treated or rejected to the environment. The treatment of the drain liquid increases overall processing cost whereas rejection of the drain liquid to the environment harms the environment.

In thermal purification systems, such as, a multi-stage flash evaporation system, a multi-effect distillation system and a mechanical vapor compression system, the contaminated water is heated and re-condensed. The foreign objects present in the contaminated water are separated during a phase transition of the contaminated water. Even though thermal purification systems are known to produce highly pure water, these systems require large amount of energy. In particular, these systems require mechanical energy to pump the contaminated water into the system or to maintain certain pressure gradients within the system. The mechanical energy required is generally more expensive than thermal energy. Moreover, these systems have a complex configuration and, thus, have very high initial costs of construction, installation and initial operation. Like the mechanical purification systems, thermal purification systems also produce a large amount of drain liquid that needs to be further treated or rejected to the environment.

Moreover, the mechanical purification systems and the thermal purification systems require pre-treatment of the contaminated water before initiating the purification. The pre-treatment of the contaminated water may itself be a costly and a complicated process in certain instances. In addition, assembling, installing, disassembling, and maintaining the mechanical purification systems and the thermal purification systems of the art are costly and complicated.

Therefore, there is a need for a purification system that is capable of purifying liquids in an economic manner. Further, there is a need of a purification system that is easy to assemble, install, disassemble, use and maintain while being environment friendly.

### BRIEF DESCRIPTION OF THE FIGURES

The accompanying figure, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a schematic diagram of a system for purifying a liquid mixture in accordance with an embodiment of the invention.

FIG. 2 illustrates flow of one or more hot industrial exhaust gases within the system for purifying a liquid mixture in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the present invention, it should be observed that the embodiments reside primarily in combinations of system elements related to system for purifying a liquid mixture using anti-scalants and hot industrial exhaust gases. Accordingly, the system elements have been represented where appropriate in the drawings, showing only those specific details that are pertinent to understanding the embodiments of the present invention so as not to obscure the disclosure with details that will be readily apparent to those of ordinary skill in the art having the benefit of the description herein.

Various embodiments of the invention provide a system for purifying a liquid mixture including a liquid and one or more anti-scalants using one or more hot industrial exhaust gases. The system includes a heat exchanger chamber and a conduit at least partially housed within the heat exchanger chamber for receiving the one or more hot industrial exhaust gases. The conduit is configured with one or more pipes capable of receiving and heating the liquid mixture using at least a part of heat energy obtained from the one or more hot industrial exhaust gases present within the conduit. The system also includes a condensation unit configured within the heat exchanger chamber to receive and condense vapors generated by heating the liquid mixture to obtain a purified liquid.

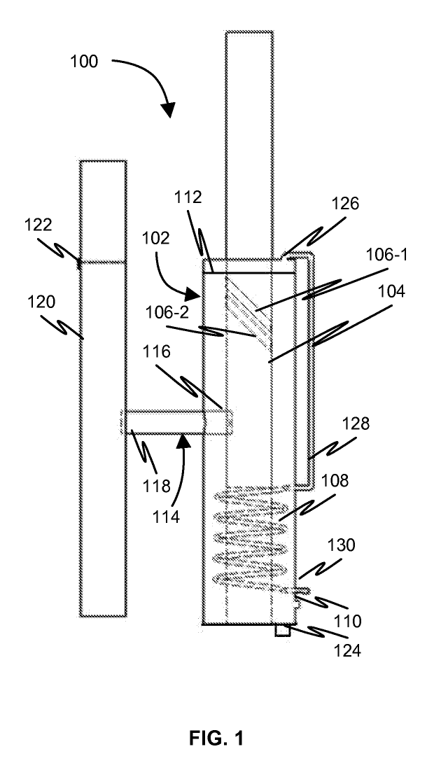

Referring to the figures, FIG. 1 illustrates a schematic diagram of a system 100 for purifying a liquid mixture in accordance with an embodiment of the invention. As shown in FIG. 1, system 100 includes a heat exchanger chamber 102, a conduit 104 at least partially housed within heat exchanger chamber 102, one or more pipes 106-n configured within conduit 104, and a condensation unit 108 housed within heat exchanger chamber 102.

Heat exchanger chamber 102 is configured to hold the liquid mixture and to heat the liquid mixture. The liquid mixture may include a liquid and one or more anti-scalants. The liquid may be, for example, but not limited to water, sewage water, industrial process water and saline water. The liquid mixture may include one or more impurities. The one or more impurities may be one or more of one or more dissolved impurities and one or more suspended impurities. The one or more dissolved impurities may be, one or more of, but are not limited to, one or more salts, one or more colorants, one or more contaminants, one or more odorants, one or more gases and one or more chemical impurities. Whereas, the one or more suspended impurities may be, one or more of, but are not limited to, one or more suspended bodies, one or more colloidal impurities, one or more contaminants and one or more microorganisms.

The one or more anti-scalants may be, for example, but are not limited to, an ionic liquid, an ionic salt, a nitrate, glycerin, ethylene glycol and a salt. The ionic salt may be, but not limited to, N-butyl-N-methylpyrrolidinium-bis(trifluoromethanesulfonyl)-imide and 1-butyl-3-methyl-imidazolium-tetrafluoroborate. The one or more anti-scalants may be selected based on a type of the liquid to be purified.

In an embodiment, system 100 may further include a liquid mixture preparing unit (not illustrated in FIG. 1) to prepare the liquid mixture. The liquid mixture preparing unit may be configured to allow mixing of a liquid to be purified and the one or more anti-scalants to obtain the liquid mixture. The liquid mixture thus obtained may then be supplied to system 100 through one or more inlets, such as, inlet 110 for purification.

In another embodiment, system 100 may also include one or more liquid mixture filtration units (not illustrated in FIG. 1). The one or more liquid mixture filtration units may be configured between inlet 110 and the liquid mixture preparing unit. In such a scenario, the liquid mixture prepared in the liquid mixture preparing unit may be transferred to the one or more liquid mixture filtration units to filter the liquid mixture. The filtered liquid mixture may then be input to system 100 through inlet 110 for purification.

Heat exchanger chamber 102 receives the liquid mixture to be purified through one or more inlets, such as inlet 110. Inlet 110 is configured at a bottom portion of heat exchanger chamber 102. Inlet 110 is configured such that when the liquid mixture is fed into heat exchanger chamber 102, level of the liquid mixture in heat exchanger chamber 102 gradually rises. In an embodiment, the level of the liquid mixture is allowed to rise up to a maximum level 112 as illustrated in FIG. 1. The level of the liquid mixture in heat exchanger chamber 102 is maintained in proximity of maximum level 112 during the purification. The liquid mixture present within heat exchanger chamber 102 comes in contact with an inner surface of heat exchanger chamber 102 and an outer surface of conduit 104.

The liquid mixture present within heat exchanger chamber 102 flows through one or more pipes 106-n, such as, a pipe 106-1 and a pipe 106-2 configured within conduit 104. As illustrated in FIG. 1, pipe 106-1 and pipe 106-2 are submerged in the liquid mixture. In an embodiment, pipe 106-1 and pipe 106-2 are positioned in an inclined manner as illustrated in FIG. 1 and hold a portion of the liquid mixture.

Conduit 104 is configured to receive and allow passage of the one or more hot industrial exhaust gases. Conduit 104 receives the one or more hot industrial exhaust gases through one or more redirection conduits, such as, a redirection conduit 114. System 100 is shown to include one redirection conduit such as, redirection conduit 114 for purpose of ease of illustration, however system 100 may include more than one redirection conduits. Redirection conduit 114 includes a first end 116 and a second end 118. First end 116 is connected to conduit 104 and second end 118 is connected to one or more sources of the one or more industrial hot exhaust gases. Thus, redirection conduit 114 is configured to supply the one or more hot industrial exhaust gases from the one or more sources to conduit 104.

The one or more sources of the one or more hot industrial exhaust gases may be, for example, but are not limited to, an industrial exhaust stack. Accordingly, system 100 may also include one or more industrial exhaust stacks, such as an industrial exhaust stack 120 that supplies the one or more hot industrial exhaust gases. The one or more hot industrial exhaust gases may be for example, but are not limited to, nitrogen, nitrogen oxides, carbon dioxide, carbon monoxide, hydrocarbons and any other hot gas that is generated as a result of an industrial process or industrial combustion of fuels. The one or more hot industrial exhaust gases possess a large amount of thermal energy. In an embodiment, the one or more hot industrial exhaust gases may have temperature ranging from 100° C. to 1000° C.

In an embodiment, industrial exhaust stack 120 may also include a valve 122 to control the flow of the one or more hot industrial exhaust gases passing through industrial exhaust stack 120. When valve 122 is in a closed configuration, the one or more hot industrial exhaust gases flowing through industrial exhaust stacks 120 are directed to the one or more redirection conduits such as, redirection conduit 114. Redirection conduit 114 in turn may supply the one or more hot industrial exhaust gases to conduit 104. Whereas, when valve 122 is in an open configuration, the one or more hot industrial exhaust gases flowing through industrial exhaust stacks 120 are not directed to redirection conduit 114.

For example, industrial exhaust stack 120 may be a chimney of a factory. Hot exhaust gases, such as, hot gases produced by combustion of fuel or as a result of industrial processes pass through the chimney. The hot exhaust gases passing through the chimney may be utilized as a source of thermal energy for purification of the liquid mixture. The chimney may be provided with a valve that controls the flow of the hot exhaust gases through the chimney. The hot exhaust gases from the chimney may be directed to conduit 104 using redirection conduit 114. Redirection conduit 114 may connect the chimney with conduit 104 for supplying the hot exhaust gases to conduit 104.

As the one or more hot industrial exhaust gases pass through conduit 104, the one or more hot industrial exhaust gases come in contact with one or more pipes thereby heating the one or more pipes, such as, pipe 106-1 and pipe 106-2. Pipe 106-1 and pipe 106-2 may hold a portion of the liquid mixture as mentioned earlier. In this case, the liquid mixture touches an inner surface (not shown in FIG. 1) of the one or more pipes. Once the one or more hot industrial exhaust gases come in contact with an outer surface the one or more pipes, heat energy is transferred from the one or more hot industrial exhaust gases to the liquid mixture.

For example, one or more pipes, such as, pipe 106-1 and pipe 106-2 heat the liquid mixture that is present within or flowing through them using a portion of the heat energy of the one or more hot industrial exhaust gases. Thus, pipe 106-1 and pipe 106-2 act as heat exchangers for heating the liquid mixture. The heating of the liquid mixture results in evaporation of the liquid mixture, which in turn generates vapors of the liquid mixture. In response to evaporation of the liquid mixture and due to the usage of the one or more anti-scalants, the one or more impurities and one or more salts present in the liquid mixture are separated as a solid precipitate. The one or more anti-scalants prevent bonding of the one or more salts and the one or more impurities to surfaces of system 100. Further, as the one or more salts and the one or more impurities have densities greater than density of the liquid, the one or more salts and the one or more impurities are separated as the solid precipitate.

The solid precipitate thus obtained tend to move under the influence of gravity. For example, solid precipitate present in the one or more pipes such as, pipe 106-1 and pipe 106-2 may pass through heat exchange chamber 102 and settle at a bottom portion of heat exchange chamber 102. These solid precipitate may need to be removed from heat exchange chamber 102. Accordingly, system 100 further includes one or more impurity collection units, such as an impurity collection unit 124 positioned at a bottom portion of heat exchanger chamber 102. The one or more impurities and the one or more salts separated from the liquid mixture as the solid precipitate may be collected in impurity collection unit 124. The solid precipitate thus obtained may then be utilized for other purposes, for example, as fertilizers. Alternatively, the solid precipitate may be disposed off safely without causing any harm to the environment unlike liquid by-products of conventional purification systems.

In an embodiment, the solid precipitate may also be subjected to one or more further processes, for example, but are not limited to, centrifugation, condensation, boiling and evaporation or any other processes known in the art for extracting solid foreign objects from the solid precipitate. In this case, the solid precipitate may be processed outside system 100. Alternatively, system 100 may also be configured to process the solid precipitate. The solid foreign objects extracted from the solid precipitate may then be utilized for other purposes, for example, as fertilizers. Alternatively, the solid foreign objects may be disposed off safely without causing any harm to the environment.

Now referring back to the vapors generated as a result of the evaporation of the liquid mixture, these vapors flow towards a top portion of heat exchanger chamber 102. In an embodiment, one or more vapor collection units such as, a vapor collection unit 126 are present at the top portion of heat exchanger chamber 102, as illustrated in FIG. 1. Vapor collection unit 126 collects the vapors and supplies the vapors through one or more vapor supplying pipes, such as, a vapor supplying pipe 128 to condensation unit 108.

In an embodiment, condensation unit 108 may include one or more coiled tubes positioned within heat exchanger chamber 102. The one or more coiled tubes may be positioned at a bottom portion of heat exchange chamber 102. Condensation unit 108 is positioned such that when heat exchanger chamber 102 holds the liquid mixture up to maximum level 112, condensation unit 108 is submerged in the liquid mixture. In an embodiment, the one or more coiled tubes are coiled surrounding conduit 104. In this case, the one or more coiled tubes may not be in contact with an outer surface of conduit 104. Condensation unit 108 condenses the vapors to produce a purified liquid. Latent heat of the vapors released upon condensation of the vapors is transferred to the liquid mixture present in heat exchanger chamber 104. Heat exchanger chamber 104 then uses the latent heat of the vapors to pre-heat the liquid mixture before the liquid mixture is heated by one or more pipes 106-n. The purified liquid obtained as a result of condensation may be output through one or more outlets, such as, an outlet 130, as illustrated in FIG. 1. The purified liquid thus obtained may be used for various purposes known in the art.

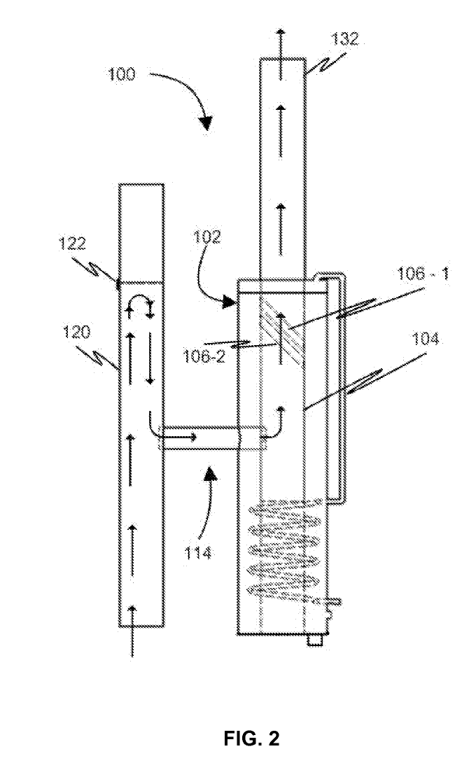

Turning now to FIG. 2, FIG. 2 illustrates flow of one or more hot industrial exhaust gases within a system 100 for purifying a liquid mixture in accordance with an embodiment of the invention. In an embodiment, the flow of the one or more hot industrial exhaust gases through an industrial exhaust stack 120 is controlled by valve 122. When valve 122 is in a closed configuration, the one or more hot industrial exhaust gases flow through industrial stack 120 and are directed to redirection conduit 114. Redirection conduit 114 that connects to conduit 104 supplies the one or more hot industrial exhaust gases to conduit 104. Conduit 104 is configured to allow passage of the one or more hot industrial exhaust gases. The one or more hot industrial exhaust gases then flow from redirection conduit 114, through conduit 104 towards an exhaust 132. The one or more hot industrial exhaust gases are then expelled out from exhaust 132.

The one or more hot industrial exhaust gases come in contact with one or more pipes 106-n while flowing from redirection conduit 114, through conduit 104 towards exhaust 132. Upon coming in contact with the one or more hot industrial exhaust gases, one or more pipes 106-n are heated. At the same time, one or more pipes 106-n may be in contact with the liquid mixture. More specifically, the liquid mixture may be present within one or more pipes 106-n and may be contact with the internal surfaces of one or more pipes 106-n. As a result, one or more pipes 106-n facilitates the transfer of a portion of heat energy from the one or more hot industrial exhaust gases to the liquid mixture thereby resulting in evaporation of the liquid mixture.

In an embodiment, a system, such as, system 100 may be a water distillation system. The heat exchanger chamber receives raw water to be distilled through one or more inlets. Prior to inputting the raw water to the heat exchanger system, one or more anti-scalants are added to the raw water. Addition of the one or more anti-scalants to the raw water facilitates in separation of one or more impurities present in the raw water as a solid precipitate.

Thereafter, the conduit receives and allows passage of the one or more hot industrial exhaust gases from one or more industrial exhaust stacks. The one or more pipes configured within the conduit are heated by the one or more hot industrial exhaust gases. The one or more pipes acts as a heat exchanger to heat the raw water present within or passing through the one or more pipes using a part of heat energy from the one or more hot industrial exhaust gases.

Heating of the raw water by the one or more pipes causes evaporation of the raw water. The evaporation of the raw water results in formation of vapors. The vapors thus formed then move to one or more vapor collection units configured at a top portion of the heat exchanger chamber. Thereafter, the vapors move from the one or more vapor collection units to one or more vapor supplying pipes that supply the vapors to a condensation unit present within the heat exchanger chamber. The condensation unit is submerged under the raw water during the distillation. The condensation unit thus condenses the vapors to obtain distilled water. Latent heat of the vapors released upon condensation of the vapors is transferred to the raw water present in the heat exchanger chamber. The heat exchanger chamber then uses the latent heat of the vapors to pre-heat the raw water before the raw water is heated by the one or more pipes. The system thus re-circulates the latent heat of the vapors and efficiently utilizes the thermal energy.

In another embodiment, a system, such as, system 100 may be a water desalination system. The heat exchanger chamber receives saline water to be desalinated through one or more inlets. Prior to inputting the saline water to the heat exchanger system, one or more anti-scalants are added to the saline water. Addition of the one or more anti-scalants to the saline water facilitates in separation of one or more salts present in the saline water as a solid precipitate.

Thereafter, a conduit of the system receives and allows passage of the one or more hot industrial exhaust gases from one or more industrial exhaust stacks. The one or more pipes configured within the conduit are heated by the one or more hot industrial exhaust gases. The one or more pipes acts as a heat exchanger to heat the saline water present within or passing through the one or more pipes using a part of heat energy from the one or more hot industrial exhaust gases.

Heating of the saline water by the one or more pipes causes evaporation of the saline water. The evaporation of the saline water results in formation of vapors. The vapors thus formed then move to one or more vapor collection units configured at a top portion of the heat exchanger chamber. Thereafter, the vapors move from the one or more vapor collection units to one or more vapor supplying pipes that supply the vapors to a condensation unit present within the heat exchanger chamber. The condensation unit is submerged under the saline water during the distillation. The condensation unit thus condenses the vapors to obtain desalinated water. Latent heat of the vapors released upon condensation of the vapors is transferred to the saline water present in the heat exchanger chamber. The heat exchanger chamber then uses the latent heat of the vapors to pre-heat the saline water before the saline water is heated in the one or more pipes. The system thus re-circulates the latent heat of the vapors and efficiently utilizes the thermal energy.

Various embodiments of the invention provide a system for purifying liquids using hot industrial exhaust gases as a source of thermal energy. The liquids may be purified without any need for pre-purification treatment of the liquids thereby reducing processing cost and processing time. Further, use of anti-scalants allows impurities in the liquids to be separated as a solid precipitate. The solid precipitate may be disposed off safely without causing any harm to the environment unlike liquid by-products of conventional purification systems that harm the environment. The system also re-circulates latent heat of vapors generated during purification process and thus efficiently utilizes the thermal energy. In addition, owing to simplicity of the design, the system may be economic and easy to assemble, install, disassemble, use and maintain while being environment friendly at the same time.

The above recognized advantages and other advantages described herein are merely exemplary and are not meant to be a complete rendering of all of the advantages of the various embodiments.

In the foregoing specification, specific embodiments of the invention have been described. However, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. A system for purifying a liquid mixture, the system comprising:
a heat exchanger chamber for heating the liquid mixture contained therewithin, the liquid mixture comprising a liquid and at least one anti-scalant;
a conduit at least partly housed within the heat exchanger chamber, the conduit configured for receiving at least one hot industrial exhaust gas;
at least one pipe configured within the conduit, the at least one pipe capable of:
receiving the liquid mixture; and
heating the liquid mixture using at least a part of heat energy obtained from the at least one hot industrial exhaust gas present within the conduit; and
a condensation unit configured to receive and condense vapors generated in response to heating the liquid mixture to obtain a purified liquid.

2. The system of claim 1, wherein the at least one anti-scalant comprises at least one of a glycerin, a salt and a nitrate.

3. The system of claim 1, the liquid mixture further comprises at least one impurity, the at least one impurity comprises at least one of a dissolved impurity and a suspended impurity.

4. The system of claim 3, wherein the at least one impurity is at least one of at least one salt and at least one contaminant.

5. The system of claim 4, wherein the at least one impurity is precipitated as solid.

6. The system of claim 5 further comprising an impurity collection unit for collecting the at least one impurity precipitated as solid.

7. The system of claim 1 further comprising at least one source unit for supplying the at least one hot industrial exhaust gas to the heat exchanger chamber.

8. The system of claim 1 further comprising a redirection conduit, the redirection conduit connecting the at least one source unit and the heat exchanger chamber for supplying the at least one hot industrial exhaust gas to the heat exchanger chamber.

9. The system of claim 8, wherein the at least one source unit further comprises a valve for controlling flow of the at least one hot industrial exhaust gas, whereby the at least one hot industrial exhaust gas is directed into the redirection conduit upon closing the valve.

10. The system of claim 1, wherein the heat exchanger chamber further comprises a vapor supplying pipe, the vapor supplying pipe collects the vapors generated due to the evaporation of the liquid mixture and supplies the collected vapors to the condensation unit.

11. The system of claim 1, wherein the liquid is at least one of a water, a saline water and a sewage water.

12. The system of claim 1, wherein the system is one of a water distillation system and a water desalination system.
